(19) United States
(12) Patent Application Publication
(10) Pub. No.: US 2025/0354951 A1
(43) Pub. Date: Nov. 20, 2025

(54) Measuring Electronic Accessibility Of Electrode Regions And Particles

(71) Applicant: Drexel University, Philadelphia, PA (US)

(72) Inventors: Maureen Han-Mei Tang, Ambler, PA (US); Karla Negrete, Philadelphia, PA (US); Sophie Lee, Boston, MA (US)

(21) Appl. No.: 19/210,464

(22) Filed: May 16, 2025

Related U.S. Application Data
(60) Provisional application No. 63/648,230, filed on May 16, 2024.

(51) Int. Cl. G01N 27/27; G01N 21/64; G01N 27/30; G01N 27/48; H01M 10/0525; H01M 10/42

(52) U.S. Cl. CPC G01N 27/27; G01N 21/6458; G01N 27/305; G01N 27/48; H01M 10/4285; H01M 10/0525

(57) ABSTRACT

Provided is a method, the method including visualizing, with electrochemical fluorescent microscopy, electronic connections between particles of active material and conductive additive in a composite battery electrode. Also provided is a testing apparatus, the apparatus including a transparent conductor; a composite battery electrode, the transparent conductor and composite battery electrode being in electronic communication with one another; a separator disposed between the transparent conductor and the composite battery electrode; a medium, the medium comprising an electrofluorophore, and the medium contacting the composite battery electrode. Also provided is a method, comprising: collecting a fluorescence image representative of a composite material that (i) comprises a plurality of particles and (ii) comprises an electrofluorophore; and estimating particles of the composite electrode that are in electronic isolation.

### CROSS-REFERENCE TO RELATED APPLICATIONS

This application claims benefit to U.S. Provisional Application No. 63/648,230, filed May 16, 2024, the entirety of which application is incorporated by reference herein for any and all purposes.

### GOVERNMENT RIGHTS

This invention was made with government support under Contract No. 1751553 awarded by the National Science Foundation. The government has certain rights in the invention.

### TECHNICAL FIELD

The present disclosure relates to the field of electrochemical fluorescent microscopy and to the field of electrofluorochromism.

### BACKGROUND

A high-throughput visualization technique for heterogeneity in lithium-ion battery electrodes (LIBE) is useful to understand battery performance on a mechanistic level. Existing approaches, however, are limited in scale and resolution. Accordingly, there is a long-felt need in the art for improved methods of visualizing heterogeneity in LIBE and other devices.

### SUMMARY

In meeting the described long-felt needs, the present disclosure provides a method, comprising: visualizing, with electrochemical fluorescent microscopy, electronic connections between particles of active material and conductive additive in a composite battery electrode.

Also provided is a testing apparatus, comprising: a transparent conductor; a composite battery electrode, the transparent conductor and composite battery electrode being in electronic communication with one another: a separator disposed between the transparent conductor and the composite battery electrode: a medium, the medium comprising an electrofluorophore, and the medium contacting the composite battery electrode.

Further provided is a method, comprising: collecting a fluorescence image representative of a composite material that (i) comprises a plurality of particles and (ii) comprises an electrofluorophore; and estimating particles of the composite electrode that are in electronic isolation.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1D. In-situ electrochemical fluorescent microscopy platform. (FIG. 1A) Schematic of electrochemical cell and imaging apparatus (FIG. 1B) 1e- and 2e-reductions for 9,10 anthraquinone (AQ) (FIG. 1C) Voltammogram of fluorophore system showing successive reductions of AQ in 0.1 M TEABF₄: PC at 100 mV/s. A background scan of 0.1 M TEABF₄: PC represented by dotted line. (FIG. 1D) Emission spectra of neutral AQ and radical AQ−.

FIG. 2. Evolution of in-situ fluorescence of NMC electrode. Lower magnification objective (5×/0.16) tracking fluorescence of 1 mm ROI over time with incremental reductive currents. Rapid fluorescence decay is observed at t=220 s post-current flow due to diffusion of AQ away from the ROI.

FIGS. 3A-3I. In-situ EFM on high-(purchased NMC532) and low-(in-house NMC111) performing composite electrodes. (FIG. 3A, FIG. 3C) Low (5×/0.16) magnification EFM of 1 mm ROI on high- and low-performing electrodes, respectively. (FIG. 3B, FIG. 3D) High (20×/0.4) magnification EFM images of high- and low-performing electrodes, revealing particle to particle resolution. (FIG. 3E) Particle delineation workflow. (FIG. 3F) Particle size distribution of segmented particles. Diameter filter highlighted in green for in-house NMC111 and in red for purchased NMC532. (FIG. 3G) Circularity distribution of segmented particles, filter highlighted in green. (FIG. 3H) Rate capability results from high- and low-performance electrodes. (FIG. 3I) Relationship between the number of segmented, filtered dead particles and discharge capacity at 1 C, normalized by number of images. Blue lines and markers correspond to NMC111 electrodes, and red correspond to NMC532.

FIG. 4. Excitation and Emission Spectra for Electrolyzed 9,10 AQ Solution, confirming that λ_{Excitation}=390 nm and λ_{Emission}=490 nm.

FIGS. 5A-5B. Voltammograms of the reduction of AQ in PC with 0.1 M of TEABF₄ at varying scan rates. (FIG. 5A) CVs of 10 mM AQ in 0.1 M TEABF₄: PC at scan rates ranging from 10-200 mV/s. (FIG. 5B) Peak reduction current vs square root of scan rate.

FIGS. 6A-6B. Limiting current calculations were verified in an ECC-Opto-10 optical cell (EL-cell, Germany) with a face-to-face orientation. (FIG. 6A) The electrode stack included an NMC532 working electrode, Whatman GF/A separator, and a sapphire optical window. A gold mesh counter electrode (1000 wire/inch gold minigrid, Buckbee Mearsis) was modified with a section of gold foil as a pseudo-reference electrode. (FIG. 6B) Stepwise chronopotentiometry is performed up to the theoretical limiting current density of −

$$0.0083 \frac{mA}{{cm}^{2}} .$$

The potential shift highlighted in blue confirms the reaction has been driven forward to produce the radical, agreeing with theoretical framework proposed. Sharp peaks at t=6 minutes and t=7 minutes correspond to are from photo-oxidation using a handheld UV-light source in-situ.

FIGS. 7A-7B. (FIG. 7A) In-situ control EFM on polished Au foil shows nearly uniform fluorescence except for surface defects on the Au (scratches, pits). Ideally uniform fluorescence in an in-situ EFM visualized surface signifies perfect electronic connectivity, indicative of a fully conductive surface. (FIG. 7B) Normalized histogram of control EFM image.

FIGS. 8A-8F. SEM images of commercially purchased electrodes (MTI) and in-house electrodes. (FIG. 8A) and (FIG. 8B) correspond to NMC532 at 1.42 kX and 3.19 kX magnifications, respectively, and showcase the variation in height at the electrode surface. In (FIG. 8A) one can see nonuniform carbon networks at the surface. One can identify the diameter for NMC532 to be between 5 to 7 um (FIG. 8B). (FIG. 8C) and (FIG. 8D) correspond to LiCoO₂ at the same magnifications. Here, one can corroborate the larger particle size and size distribution of active particles, with the reported average reported by the manufacturer as 12 um. (FIG. 8E) and (FIG. 8F) belong to in-house NMC111, at 1.42 kX and 3.19 kX magnifications respectively, with averaged active particle size of 12.2 um.

FIGS. 9A-9F. Examples of discarded images from EFM image-set. (FIG. 9A), (FIG. 9C), and (FIG. 9E) are lower magnification images of the entire 1 mm ROI of three examples of discarded images: gas bubble formation, artefacts from debris, and cracking. (FIG. 9B), (FIG. 9D), and (FIG. 9F) are at a higher magnification and highlight the challenges of focusing in the presence of such artifacts.

FIGS. 10A-10I. Example of particle delineation workflow. (FIG. 10A) An original image. Metadata provides scaling conversion of 3.173 pixels/um. (FIG. 10B) Pixel intensity distribution, threshold is highlighted in red. (FIG. 10C) Binarized image showing blobs, as isolated and in agglomerates. (FIG. 10D) Morphological opening is applied to binarized image to remove small artifacts before segmentation. (FIG. 10E) Distance mapping is performed to create a gradient between foreground pixels (blobs) and background pixels (not blobs). (FIG. 10F) Watershed algorithm is used to segment agglomerated blobs. Now segmented, the image is cleaned up by applying a morphological operation which discounts fragmented blobs touching the perimeter (FIG. 10G). Segmented components undergo feature extraction (FIG. 10H) and are displayed overlapping onto the original image for verification (FIG. 10I)

FIGS. 11A-11F. In-situ EFM on a variety of composite electrodes at low (5×/0.16) and high (20×/0.4) magnification. Low magnification (FIG. 11A, FIG. 11C, and FIG. 11E) and high magnification (FIG. 11B, FIG. 11D, and FIG. 11F) images of LiCoO₂ (active particle size: 12 um), purchased NMC532 (active particle size: 5-7 um), and in-house NMC111 (active particle size: 10 um), respectively.

FIG. 12 provides an exemplary, non-limiting depiction of the disclosed technology.

FIG. 13 demonstrates that 9,10 AQ in aprotic solvents undergoes two successive one electron reductions. The first converts the fluorophore to its stable radical anion, and the second reaction produces a non-fluorescent product. Both reactions can be corroborated experimentally. Without being bound to any particular theory or embodiment, the first reduction can occur at 1.95 V, which is outside the stability window for battery electrode. This ensures no interference, and one can take care to characterize the first reaction only.

FIG. 14 provides illustrates that electrolysis confirms formation of the fluorescent radical AQ⁻. As shown, fluorometry is conducted on the electrolyzed AQ solution to obtain excitation/emission spectra for the radical anion. Peak excitation and emission wavelengths are identified: a Stokes shift of 94 nm indicates favorable color differentiation and better resolution for imaging, and a 200% increase in fluorescence, indicating production of the fluorescent radical anion after electrolysis.

FIG. 15 demonstrates that a reaction can be limited by particle-to particle resistances. As shown, we sweep the reaction at different scan rates to examine the scan rate dependence, and minimal peak splitting is indicative of fast kinetics, confirming that the reaction is limited by the expected particle to particle resistances, and not kinetics of the electrolyte.

FIG. 16 illustrates direct calculation of diffusion limited reducing current. As shown, a reactor can include a stacking orientation that lets one assume heterogenous electron transfer at the surface. Assuming diffusion is the only mass transfer contributor, we use Fick's law, which relates the amount of AQ reduced at electrode surface to electrolyte solution diffusional properties, and from this, one can obtain an expression for the current necessary to generate the ion radical.

FIG. 17 illustrates confirming limiting current calculations experimentally. As shown, to test theoretical calculations, the optical cell is adjusted to incorporate a gold reference and FTO counter, also the window. Taking into account the thick fiberglass separator used here, one can calculate the limiting current density for the reaction to be −0.0083, which can be confirmed experimentally by a shift in potential at the corresponding current density, indicating a reduction of AQ.

FIG. 18 illustrates an example evolution of in-situ fluorescence of NMC using EFM. As shown, one can modify an optical half-cell for operando imaging. We keep the FTO window but swap out the thick separator with an ultrathin polyethylene separator with 1 mm ROI cut out. This restricts the reaction to ROIs which one visualizes. The theoretical current density here is −9.2, which we chose to modulate 80% of to ensure reproducibility, and stepwise chronopotentiometry was performed, up to 80% of this modulating reductive current.

FIG. 19 illustrates that EFM can rapidly characterize short-range contacts in a composite electrode.

FIG. 20 illustrates that low performance electrodes map to fluorescent heterogeneity. To investigate differences in local electronic accessibility between low- and high-quality electrode, one can image lab-made and purchased NMC. As seen, low quality electrodes were highly heterogenous having dark spots of same size and circularity to active particles, purchased NMC on the other hand, exhibited fewer discrete dark blobs.

FIG. 21 provides an example particle detection workflow.

FIG. 22 illustrates that more dead particles correlate to worse rate performance in NMC electrodes. As shown, particle statistics were performed on a library of low and high performing electrodes where E1-11 are all in-lab produced from a library. The average number of disconnected particles was correlated to average discharge capacity at 1 C, and statistics evidence was found, supporting a negative correlation for a CI of 95.

FIG. 23 illustrates a machine-learning approach to use EFM images as a prediction tool.

FIG. 24 provides EFM experimental schematic (top): mechanism to characterize electronic accessibility (bottom).

FIG. 25 provides electronic accessibility of (left) commercial NMC electrode and (right) in-house NMC electrode showing isolated particles, inactive areas, and hot-spot active particles. Scratch marks on the left image are artifacts from reusing the CE.

FIG. 26 provides example data, in which individual particles (black) are disconnected from conductive CBD (bright).

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having.” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value: they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4.

Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Any embodiment or aspect provided herein is illustrative only and does not limit the scope of the present disclosure or the appended claims. Any part or parts of any one or more embodiments or aspects can be combined with any part or parts of any one or more other embodiments or aspects.

Electronic connections between active material particles and the conductive carbon-binder-domain govern the rate capability and lifetime of high-energy commercial Li-ion batteries (LIB). This work develops an in-situ electrochemical fluorescent microscopy (EFM) technique that maps fluorescence intensity to these local electronic connections. Specifically, rapid redox kinetics of an electrofluorophore translates to reaction distributions that are limited by electronic accessibility of battery electrode regions and individual active material particles. This technique can visualize hot-spots, dead zones, and isolated particles on the electrode surface. EFM characterization of a series of LiNi_{0.33}Mn_{0.33}Co_{0.33}O₂ electrodes across processing parameters finds a significant negative correlation between the number of disconnected active particles and the rate capability. This low-cost technique provides quantitative mesoscale characterization of commercial LIB electrodes with fast throughput (<60 s) to facilitate rapid research and development and provide manufacturing quality control.

Exploiting high-energy materials in commercial lithium-ion batteries can entail utilizing the active materials while minimizing inactive components, such as conductive carbon binder domain (CBD), as electronic resistance between active material particles and the CBD is known to prevent full state-of-charge (SOC) in battery operations. Some studies have shown that, at commercially relevant concentrations of active material (>95 wt. %), performance is limited by short-range electronic contacts between particles of cathode active material and the CBD, rather than by ion transport. Electrode failure over long cycling also typically occurs at isolated or weakly connected particles that experience extreme voltages. Direct measurement of local, particle-scale electronic contacts would therefore promote rapid prediction of electrode performance for improved battery research and manufacturing quality control.

Despite the importance of these contacts, existing methods do not measure these contacts directly. Electrochemical impedance spectroscopy (EIS) cannot characterize particle-to-particle resistances, as measurements reflect the path of least resistance. Measurements of electronic resistances at the sub-mm scale have been conducted using a four-point probe with dimensions of 70-200 μm, but limitations with probe spacing, as well as the line-scan nature of this technique, make the technique unsuitable for characterizing single-particle contacts.

In an alternative approach, the reflectivity of active metal oxide particles has been linked to state-of-charge using operando spectroscopic or combinatorial microscopic techniques, such as operando optical microscopy and modeling, scattering, or reflectance microscopy. Yet, these microscopy methods risk skewed results stemming from differences in reflectivity at particle interfaces, leading to artifacts between particles that may mimic heterogeneities. This is particularly true in the case of composite battery electrodes, where thicknesses and roughness can vary widely. Beyond this, many of these techniques are available only at specialized synchrotron facilities which are not available to most researchers. A high-throughput technique based on easily accessible equipment would permit users to elucidate the relationship between electronic accessibility and battery performance.

As described herein, it was hypothesized that in situ electrochemical fluorescent microscopy (EFM) could visualize and quantify local electronic contacts between active material particles and the CBD in commercial LIB composite electrodes. Fluorescent microscopy offers fast (<100 ms), high-resolution (800 nm) imaging capabilities over large areas, enabling in-depth spatial and temporal analysis. The disclosed technique relies on the principle of electrofluorochromism, in which fluorescence is reversibly (de) activated upon electrochemical redox. Here, particles of LiNi_{0.33}Mn_{0.33}Co_{0.33}O₂ (NMC) that are well connected to the current collector via the conductive CBD can transfer an electron to the fluorophore, while particles or regions with high electronic resistance are not reactive. The fluorescence intensity therefore corresponds to the local reaction rate, which is in turn limited by electronic connectivity.

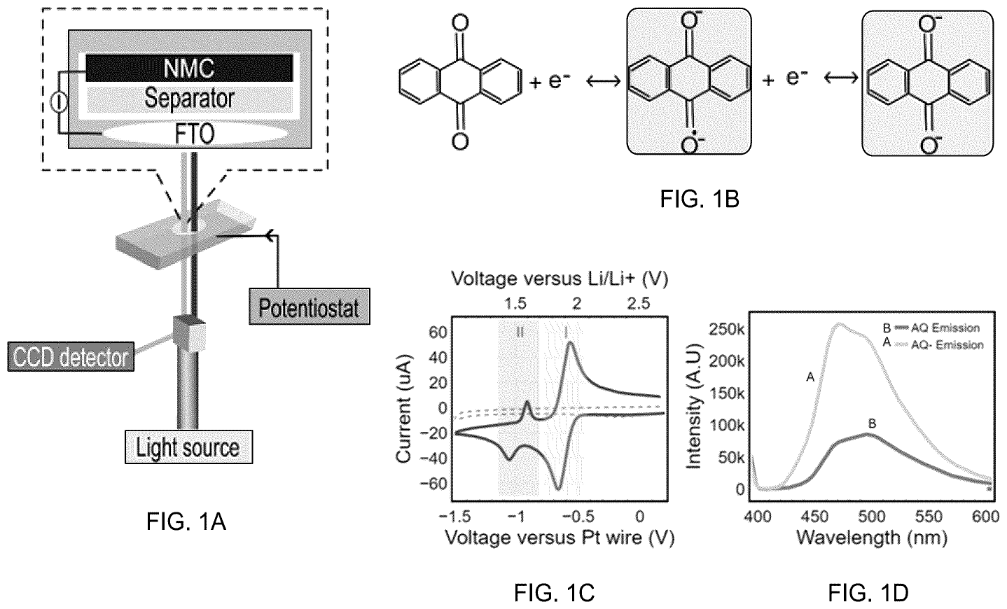

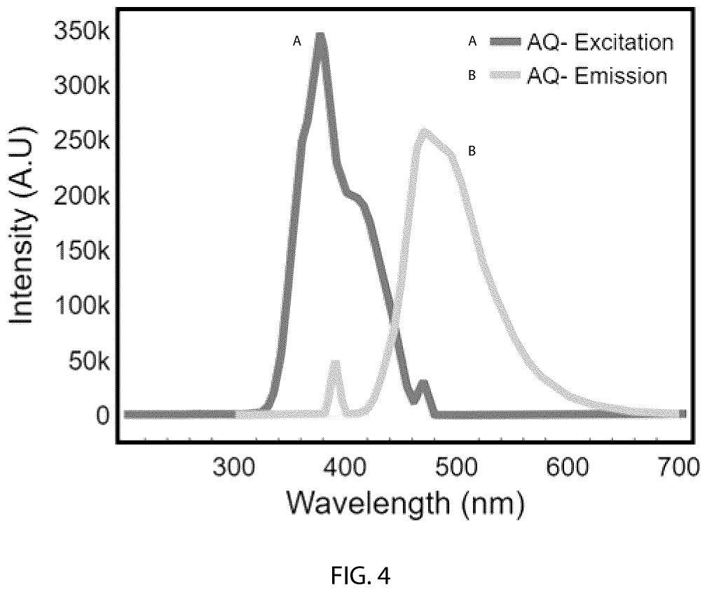

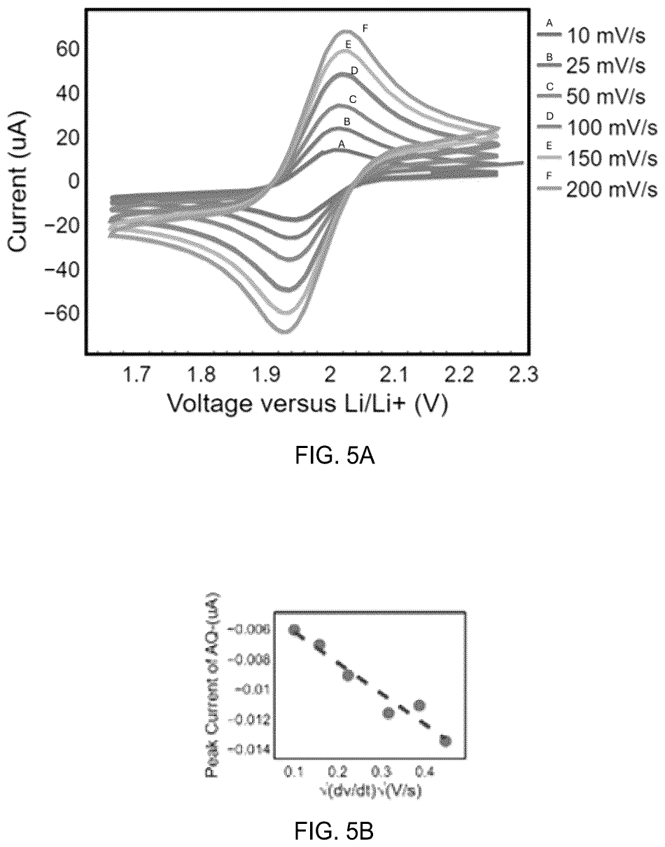

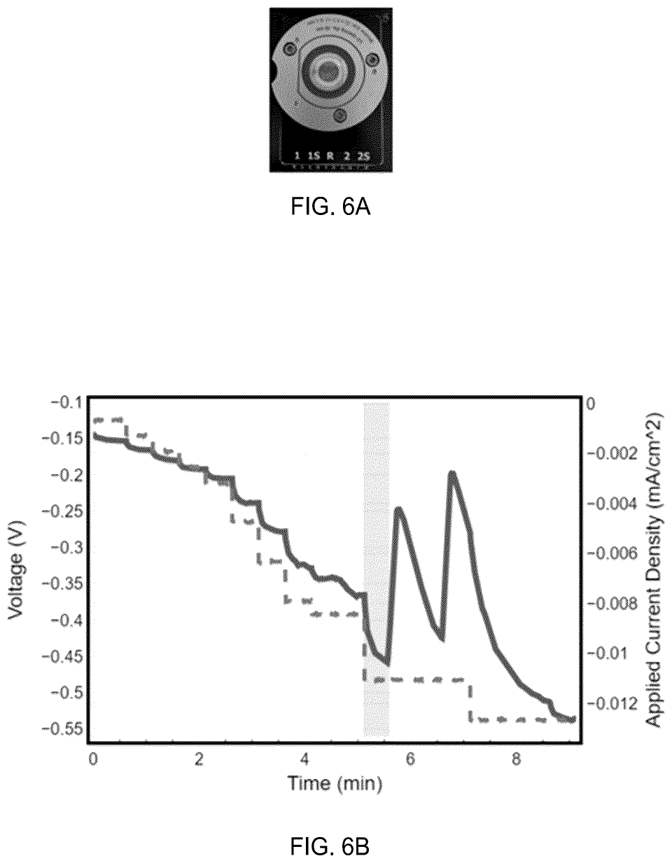

As a non-limiting example, we utilized the fluorophore 9,10-anthraquinone (AQ) which in its neutral state is non-fluorescent, but upon electrochemical reduction fluoresces at 475 nm when excited at 375 nm. AQ was selected primarily due to its full electrochemical reversibility and fast kinetics, which are outside the operating potential regions for LIB cathode materials, though it should be understood that these criteria are exemplary only and are not necessarily determinative in all cases. AQ is reduced to fluorescent AQ⁻ at 1.95 V versus Li/Li before a second reduction to non-fluorescent AQ²⁻ at 1.40 V versus Li/Li (FIG. 1C). The scan-rate dependance of AQ (FIG. 4) shows minimal peak splitting. indicating reversible kinetics. These results confirm that the first reduction reaction is limited by the electronic resistance of the electrode, not the intrinsic reaction kinetics. Fluorometry of 1 mM AQ, before and after electrolysis at 1.95 V versus Li/Li⁺+in FIG. 1D confirms that the radical anion is excited at 375 nm and emits at 475 nm, with a Stokes shift of 95 nm. A Stokes shift greater than 70 nm provides better resolution during microscopy. The fluorescent signal increases by 200% after electrolysis, confirming that electrochemical reduction of AQ at 1.95 V produces the fluorescent radical anion.

To demonstrate the direct manipulation of fluorescence via electrochemical reduction, in-situ chronopotentiometry was performed. Sealing against atmospheric oxygen was accomplished in a commercial optical cell (El-cell), which is compatible with a widefield microscope. The electrochemical cell houses a 10-mm composite battery electrode as the working electrode (WE). A custom transparent conductor (fluorine-doped tin oxide, FTO) window as the counter electrode (CE) allows visualization of the electrode surface while electrochemically regenerating the reduced fluorophore (FIG. 1A). A thin (25.4 um) non-porous polytetrafluoroethylene (PTFE) separator is positioned between the conductive window CE and WE. Laser-cut holes constrain the reaction to 1 mm diameter regions of interest (ROIs): this geometry facilitates straightforward visualization and rapid fluorophore diffusion due to the absence of porosity and tortuosity.

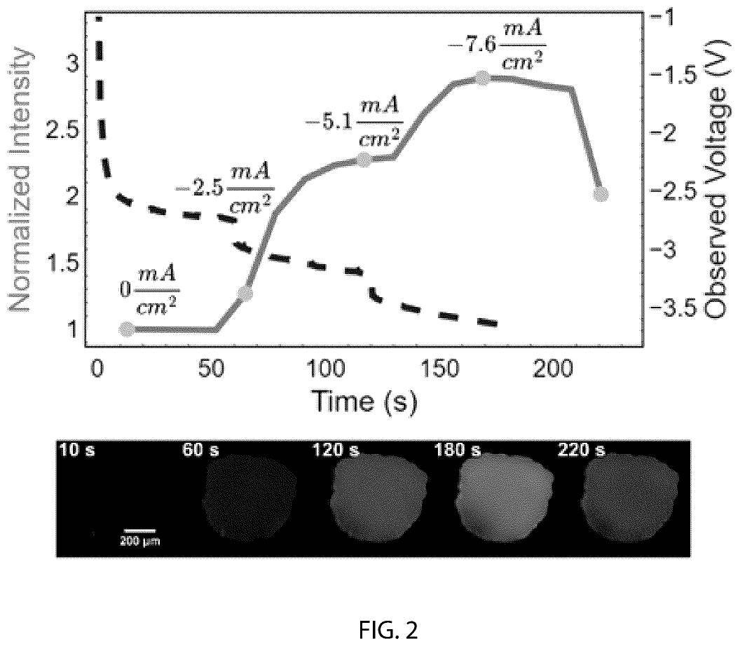

In-situ EFM of a commercial NMC electrode is shown in FIG. 2. We monitored fluorescence while incrementally increasing the reduction current density from open circuit to −2.5, −5.1, −7.6 mA/cm². Although the system does not (de) intercalate Li⁺, these current densities correspond to C-rates of approximately 2 C, 3 C, and 4 C. In the absence of current (t=0), no fluorescence was observed. As current increased, fluorescence also increased, consistent with expectations. Upon stopping current flow at 180 seconds, fluorescence decayed rapidly as AQ diffused away from the surface. FIG. 2 demonstrates a clear mechanism for modulating fluorescence via cathodic current. The diffusion-limited current for AQ, based on Fick's Law, is calculated as −9.23 mA/cm² (approximately 6 C). Consistent with theory, it was found that exceeding this current led to electrolyte decomposition, gas bubbles, and the formation of the AQ²⁻ dianion. Limiting current densities to 80% of this limiting current optimizes the tradeoff between higher fluorescent signal and experimental complications.

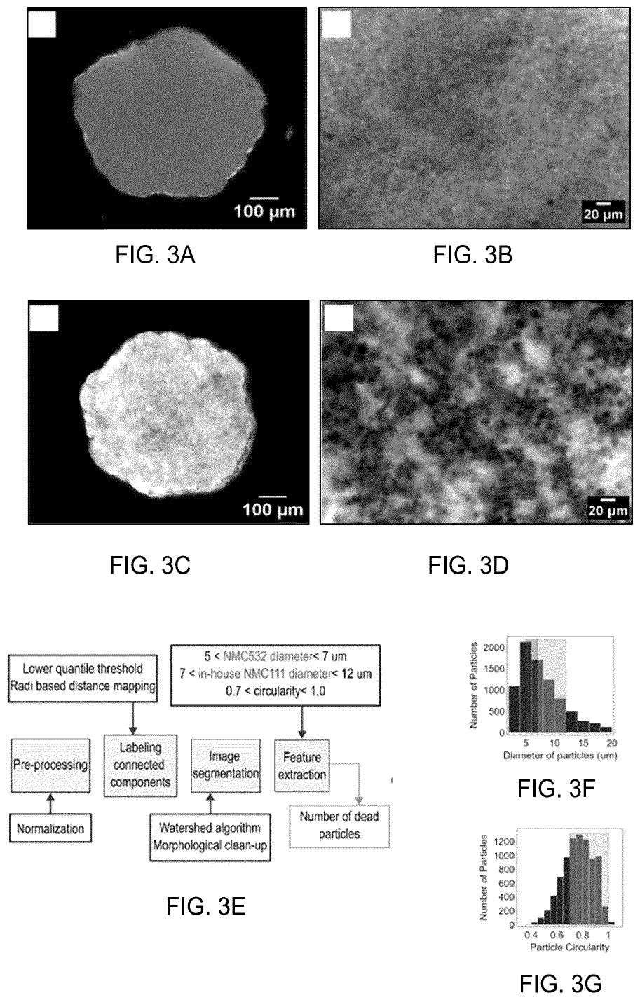

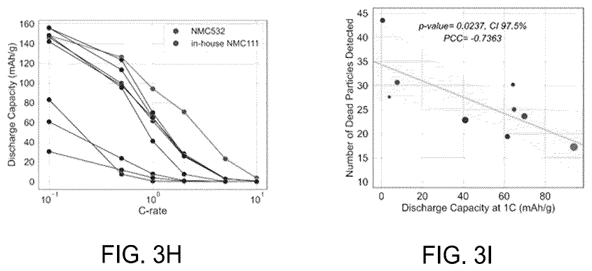

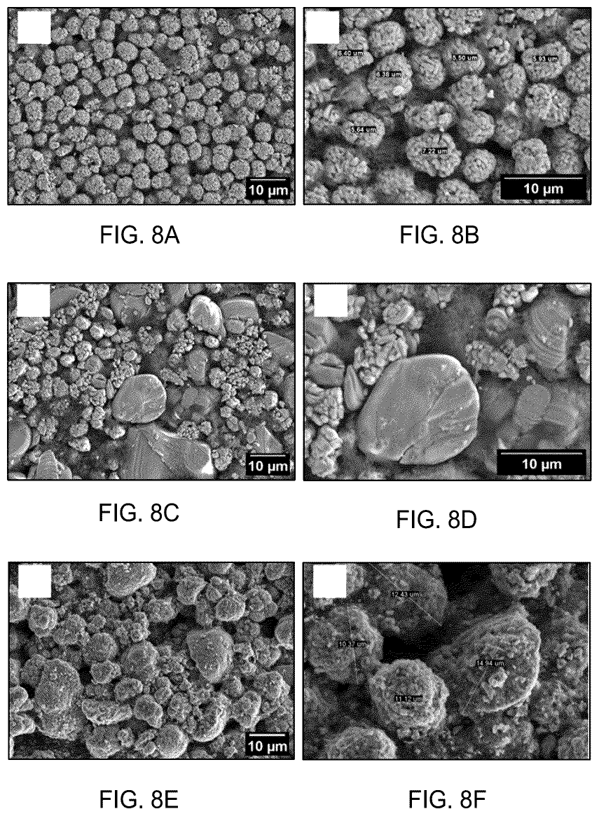

Having established the relationship between applied current, AQ formation, and fluorescent intensity, it was next determined how fluorescent images relate to electronic accessibility. Commercial electrodes (95% NMC532, 2.5% carbon, 2.5% PVDF) have been highly optimized and should yield highly uniform electronic connectivity with low resistances between individual particles and the CBD despite high loading of active material. In contrast, electrodes fabricated in-house (95% NMC111, 2.5% carbon, 2.5% PVDF) have highly variable performance depending on processing conditions. These are denoted as ‘high performance’ and ‘low performance’ electrodes, respectively. Although the metal oxide stoichiometry differs, NMC111 and NMC532 are both electronic insulators and should therefore behave identically for EFM. FIG. 3A shows EFM images of both electrodes. At a low-numerical-aperture (NA) microscope objective, with a minimum lateral resolution of 1.51 μm, the entire 1 mm ROI is relatively homogeneous for the high-performance electrode, while the low-performance electrodes show dark spots, both in isolation and agglomerations. A higher-NA object, with a minimum lateral resolution of 0.61 μm, reveals that the low-performance electrode exhibits dark blobs of approximately 10 μm in diameter. One can attribute these blobs to isolated particles of NMC based on the match between particle size, shape, and diameter as well as consistency with our hypothesized mechanism (FIG. 3D). High-performance electrodes, in contrast, exhibit a more uniform fluorescence with fewer dark blobs (FIG. 2). SEM images reveal that the average observed diameter of purchased NMC532 is 6.33 μm, whereas the average of the in-house NMC111 is 12.2 μm (FIG. 8B, 8F). Without being bound to any theory or embodiment, the distinct patterning observed during EFM of NMC532's active particles may be due to differences in surface topology, evident in SEM images as well as the electronic accessibility of particles. Overall, when compared to poorly processed electrodes (FIG. 3D), purchased NMC is still objectively more uniform in fluorescence and exhibited fewer discrete dark blobs.

FIG. 3D shows qualitatively that dark blobs corresponding to electronically isolated particles are more prevalent in low- than in high-performance electrodes. To quantitatively correlate the number of dark blobs to battery rate performance, EFM was performed on a library of low- and high-performing NMC electrodes, as measured by coin-cell rate capability data. High magnification EFM images were captured in under 60 seconds while passing current of −7.6 mA/cm². Subsequently, image processing and analysis were conducted on a substantial and swiftly acquired image dataset (N=103), which was refined to exclude samples which suffered from visible scratches or cracking, gas bubble formation, or extraneous debris (N=78).

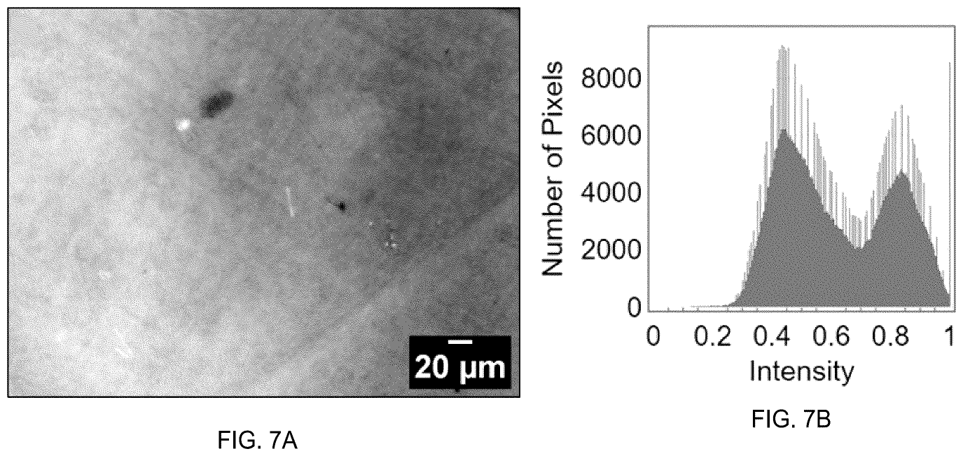

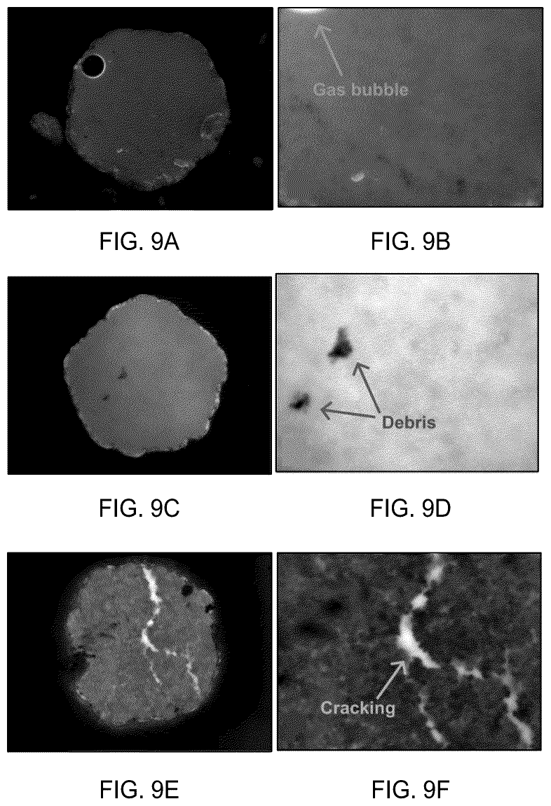

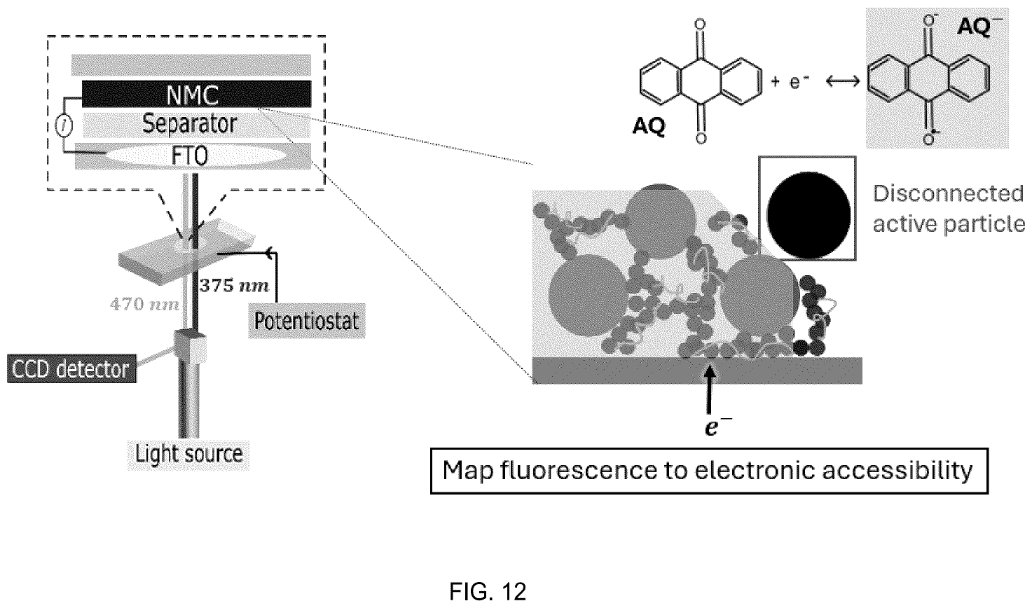

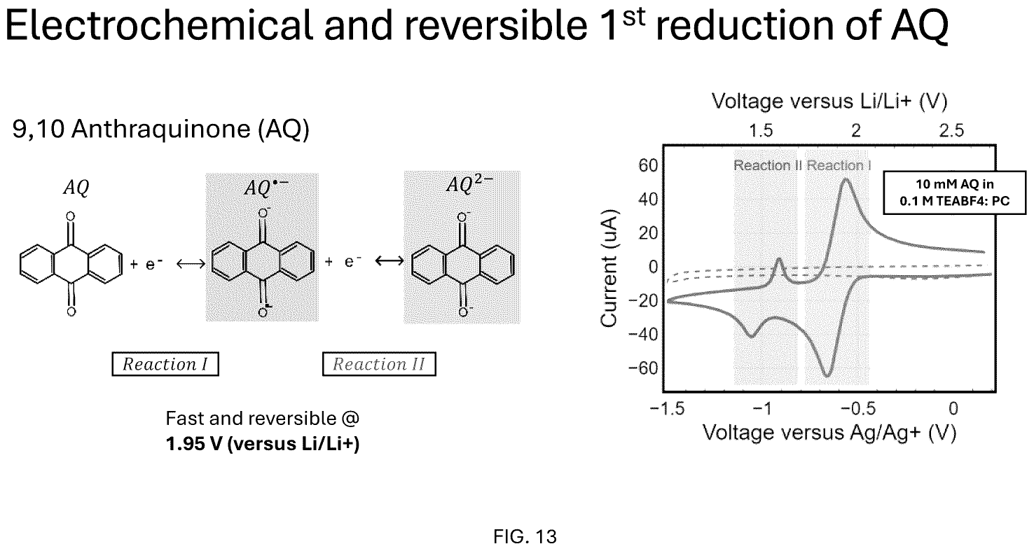

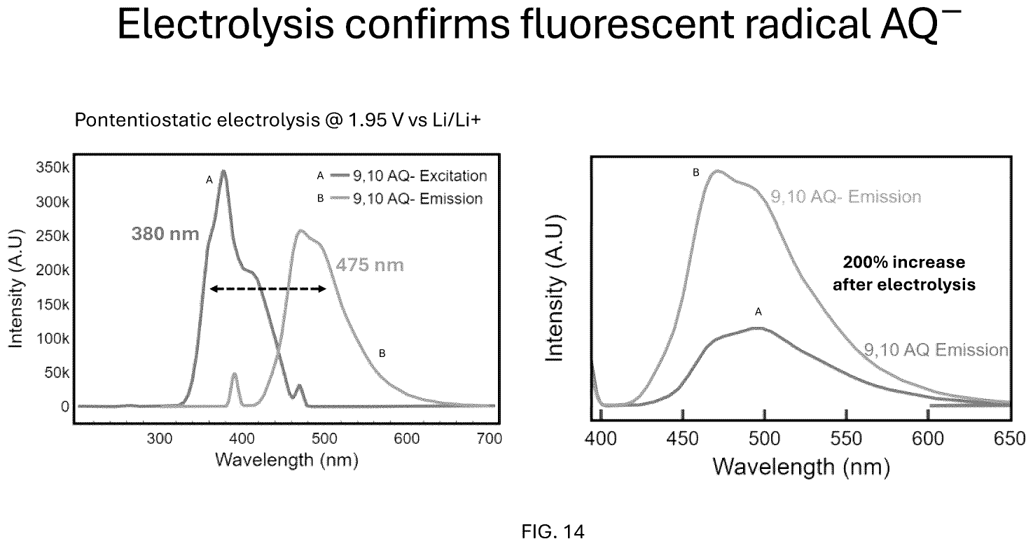

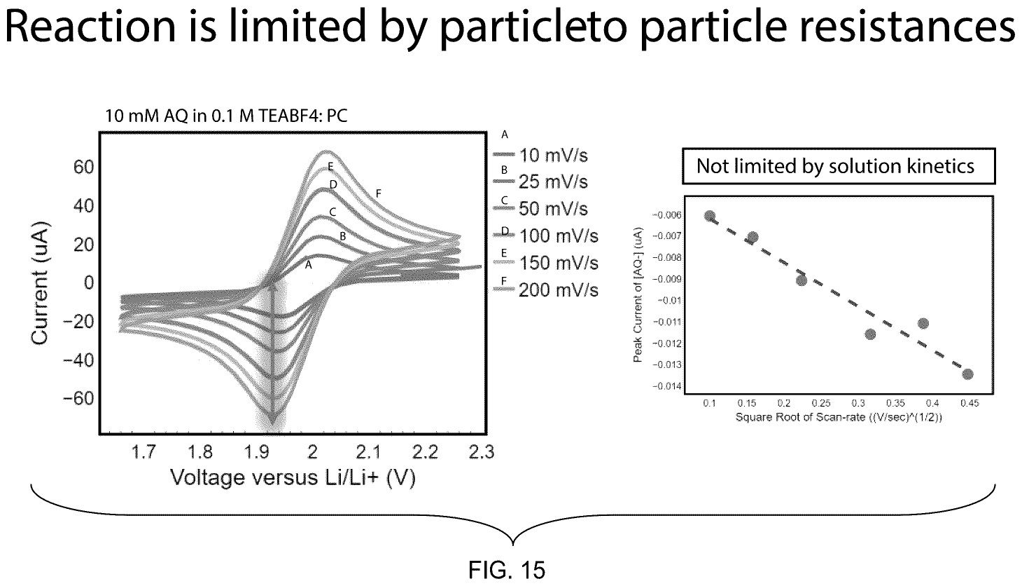

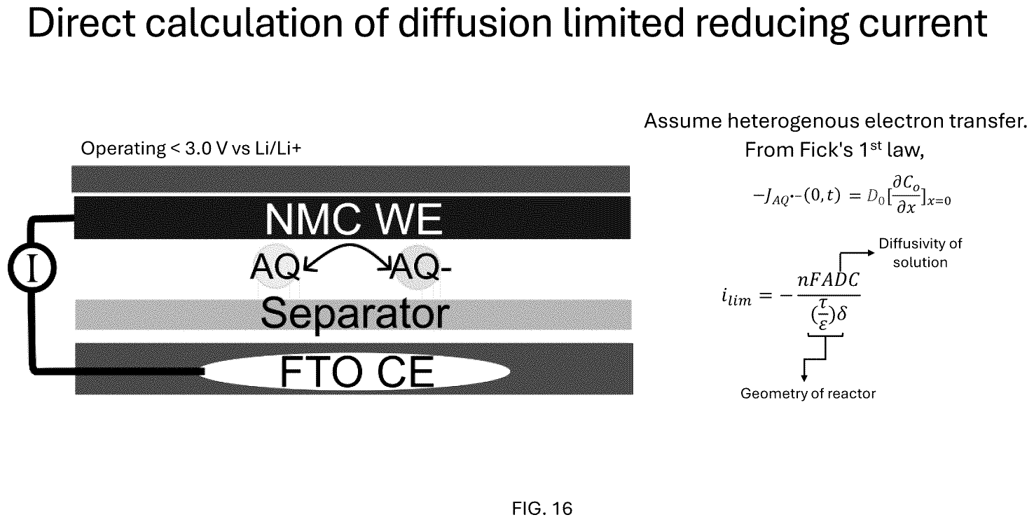

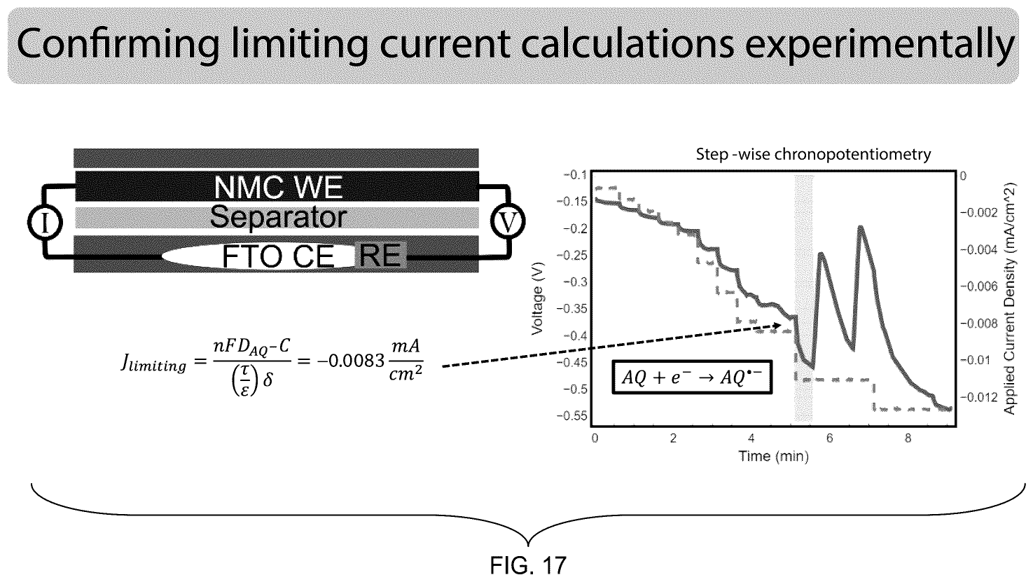

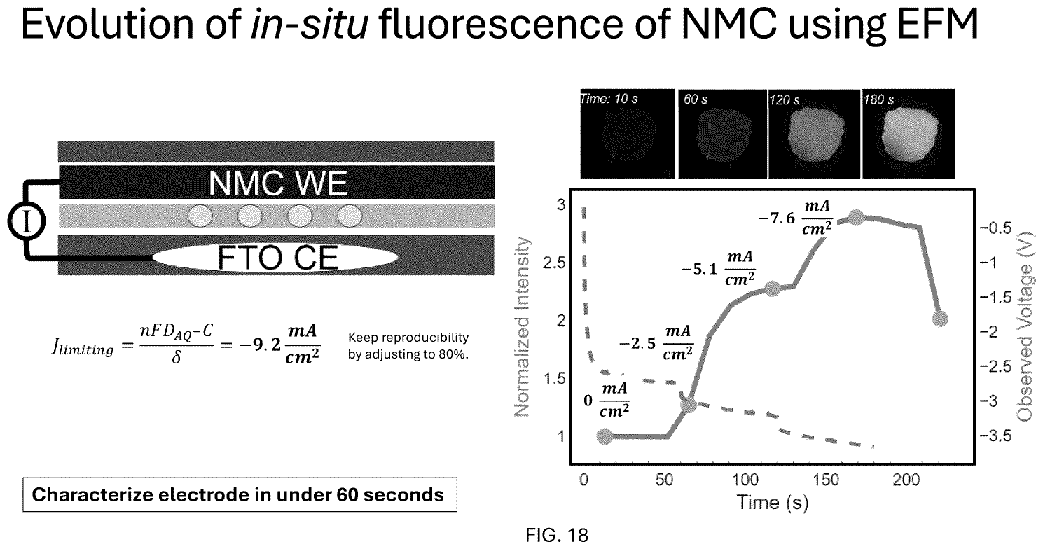

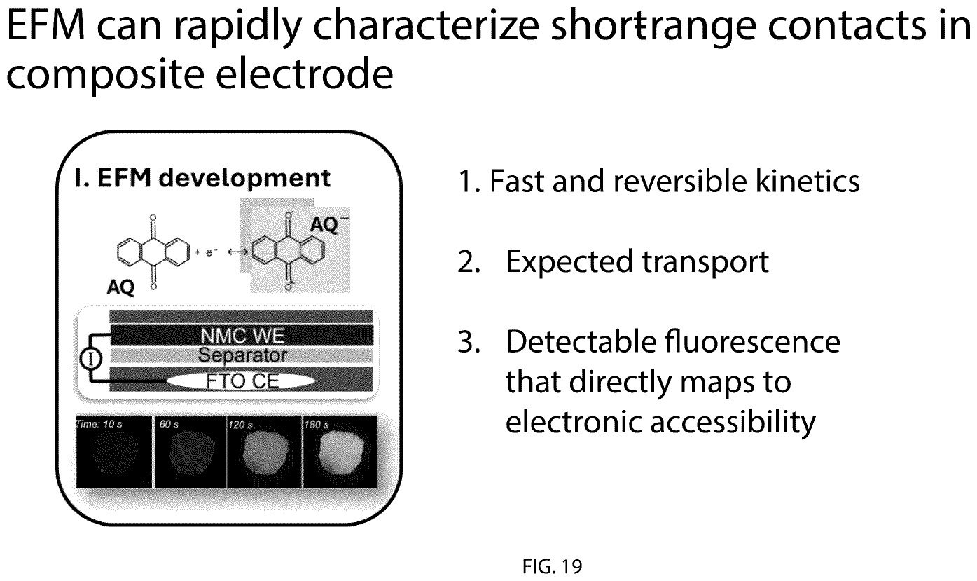

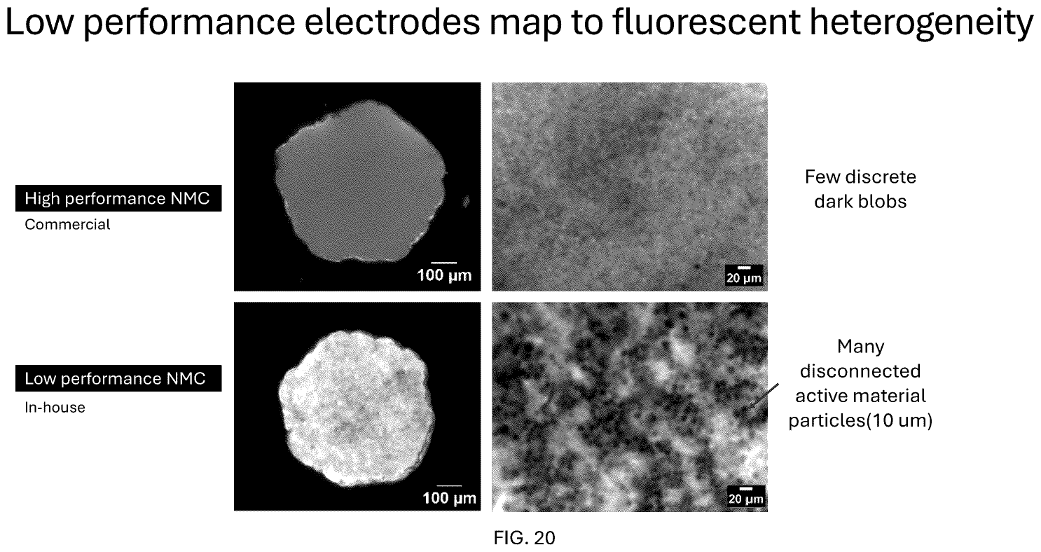

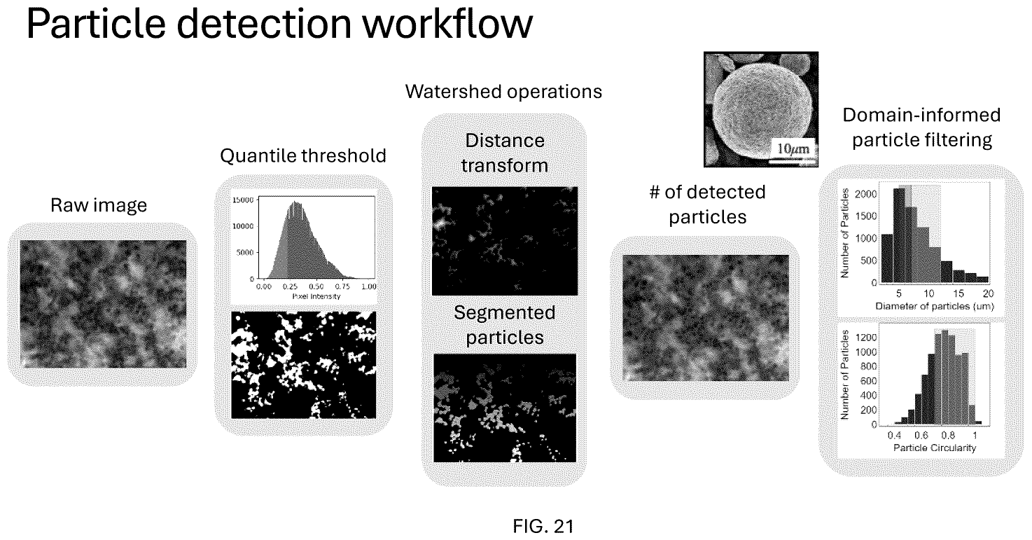

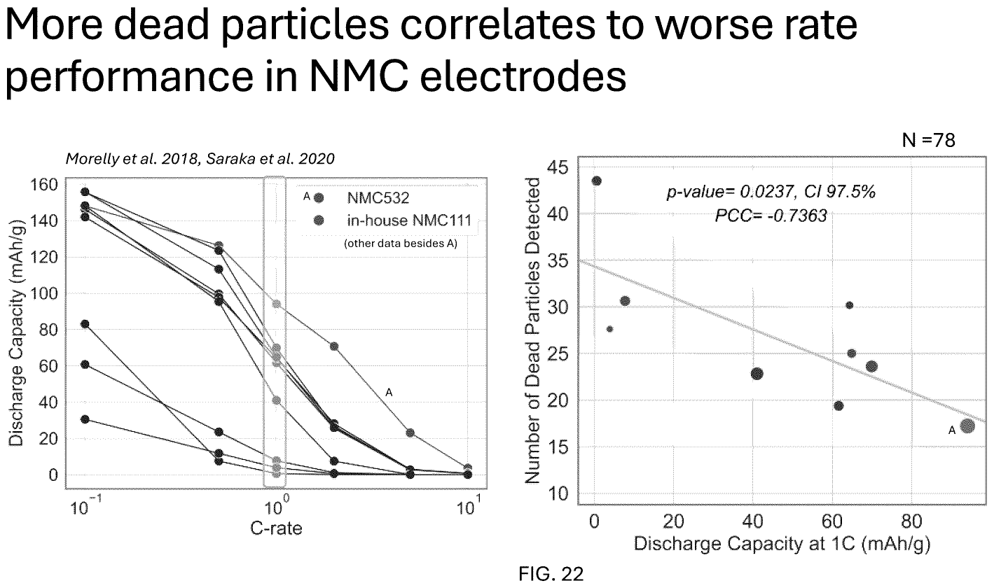

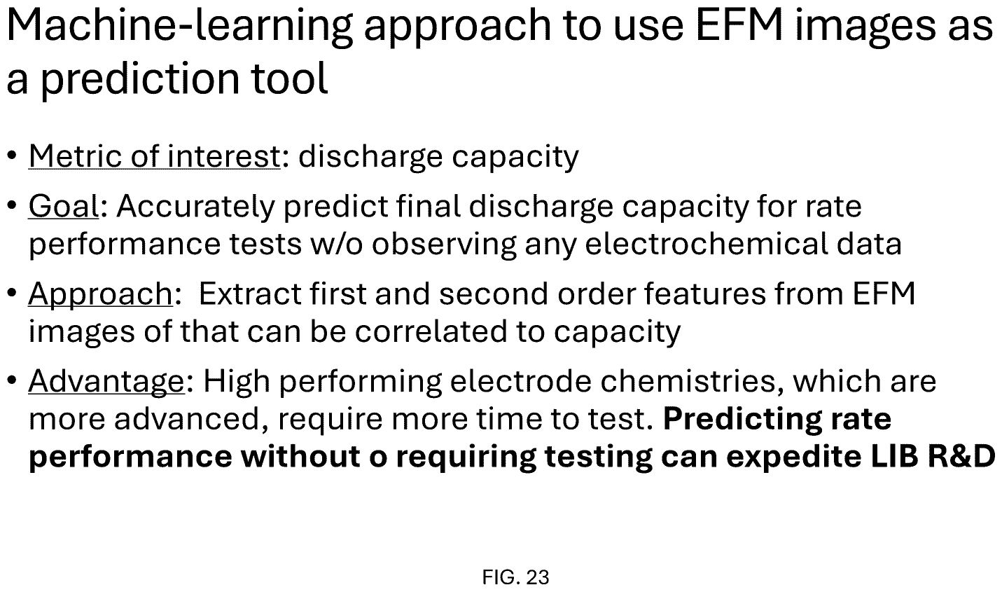

FIGS. 9B, 9D, and 9F show examples of these artifacts, which prevented focus and rendered images unsuitable for analysis using our algorithm. One can then apply a physics-informed segmentation method to classify dark blobs as isolated particles or optical artifacts (FIG. 3E). Image intensities are first normalized from 0 to 1, then binarized using the 65th percentile of the median intensity as a method to dynamically delineate the darkest pixels for segmentation. Domain-specific knowledge of particle Feret diameter and circularity guides the filtering of segmented regions. For instance, only blobs with diameter consistent with known diameter (5-7 μm for NMC532, FIG. 8B and 7-12 μm for NMC111, FIG. 8F) are included in the analysis. Therefore, segmented particles outside these specified diameter ranges were excluded from the count (FIG. 3F). Similarly, only blobs with circularity values from 0.7 to 1 were counted (FIG. 3G). Correlating the average number of segmented particles per electrode ROI with the electrode discharge capacity at 1 C reveals a statistically significant negative relationship (regression coefficient: −0.169, 97.5% CI, p=0.0237). A Pearson correlation coefficient (PCC) measures the linear relationship between the two variables: we determine a value of −0.736, indicating a strong negative linear correlation. The markers in FIG. 3I reflect the average number of detected blobs per electrode image, with the largest marker size representing a sample set of 14 images and the smallest corresponding to 5 images. One can highlight that purchased NMC532 consistently exhibits a low frequency of detected blobs.

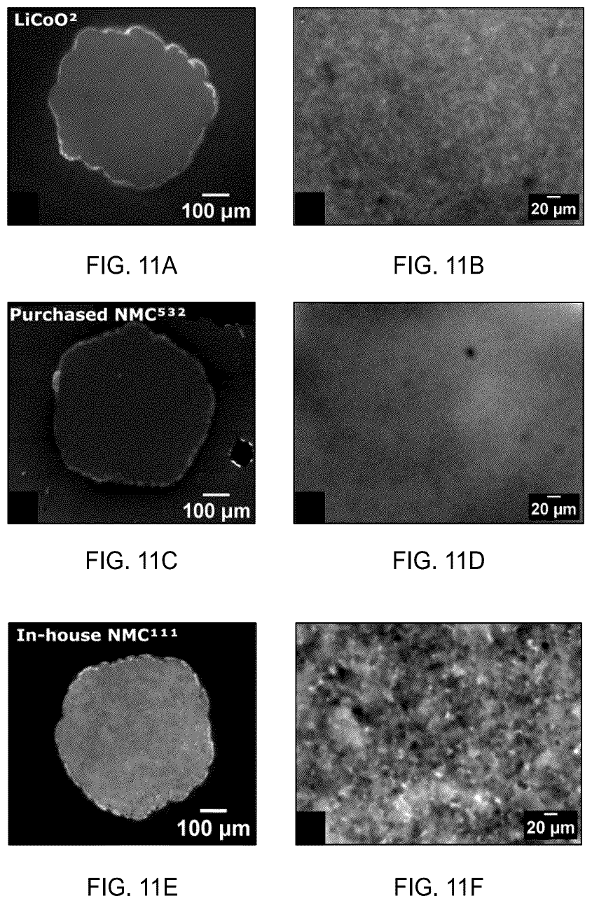

In summary, provided is an accessible method to rapidly study electronic resistances in composite electrodes. EFM enables differentiation of distinct features linked to variations in electronic connectivity among particles within electrodes. Also disclosed is a straightforward example of feature extraction to illustrate this method's potential for relating images of electronic connectivity to battery performance. EFM is material-agnostic and can be used to characterize many composite electrodes with micron-scale particle sizes (FIGS. 11A-11F). The relative speed and ease of this experimental method has application as a tool for quality control in manufacturing or a rapid prediction method in research and development.

### Experimental Methods

Materials: 9,10 Anthraquinone (AQ, 98%), tetraethylammonium tetrafluoroborate (TEBAF₄. 99%), and anhydrous propylene carbonate (PC, 99.7%) were purchased from Millipore Sigma. AQ was stored in an argon-filled glovebox (02<21.7 PPM, H2O<1.2 PPM). TEABF₄ was dried at overnight 120 C under 0.9 MPa in a vacuum oven before transfer to the glovebox. Solutions of 0.1M TEABF₄ in PC were further dried with 3 A molecular sieves (Millipore Sigma) for 72 hours. Solutions were stored in amber vials to minimize light-induced side reactions or quenching.

Electrochemical Characterization: Electrochemical characterization of AQ, was conducted with a BioLogic potentiostat in a glovebox with 3 mm glassy carbon disk working electrode (Basi), platinum wire counter electrode, and platinum wire pseudo-reference electrode. The platinum pseudo-reference electrode was calibrated as −0.79 V versus the ferrocene/ferrocenium redox couple, which has a known potential of 3.25 V versus Li/Li⁺.

Fluorescence spectroscopy: Fluorometry was conducted using a Shimadzu Spectro-fluorophotometer RF-6000 on neutral and electrolyzed AQ solutions. The neutral solution consisted of 10 mM AQ in 0.1 M TEABF₄ in PC. The solution was electrolyzed for 8 minutes in a three-electrode cell at −0.56 V versus reference (1.95 V versus Li/Li) corresponding to the expected potential of the first reduction reaction. Solutions were tested immediately after electrolysis to prevent oxidation or photoreduction.

Battery testing: NMC111 electrode sheets were obtained and vacuum-dried overnight at 120° C. to eliminate residual moisture. These electrodes contained 95 wt. % of LiNi(0.33)Mn(0.33)Co(0.33)O2 (NMC) with 10 μm average particle size, 2.5 wt. % carbon black, 2.5 wt % PVDF, and diverse processing parameters. The rate capability of these in-house NMC111 electrodes was previously reported by averaging across four-coin cells. In-house NMC111 electrodes were compared to a purchased NMC532 electrode from MTI, used without modification. Purchased NMC532 electrodes underwent electrochemical testing with an Arbin battery cycler. Five-coin cells were conditioned over four cycles at 0.1 C from 3.0 to 4.3 V, then discharged at rates of 0.5, 1, 2, 5, 10, and again at 0.5 C. Cells were charged at 0.1 C between discharges.

In-situ Optical Experiments: 10 mm electrode discs were punched and were arranged in an ECC-Opto-10 optical cell (El-cell) with a face-to-face orientation. The cell included a composite or foil working electrode, 25 μm-thick PTFE separator with laser-cut holes (McMaster), and a custom 1.1 mm thick conductive FTO window (Saida Glass Co.), all assembled and sealed inside the glovebox. Images were acquired using a Zeiss AxioObserver wide-field microscope equipped with 375 nm excitation and 515 nm emission filters, utilizing Objective EC Plan-Neofluar 5×/0.16 M27 (low magnification) and Objective LD Plan-Neofluar 20×/0.4 Corr Ph2 M27 (high magnification) lenses, while applying constant current with a BioLogic potentiostat.

### Additional Disclosure

A high-throughput visualization technique for heterogeneity in lithium-ion battery electrodes (LIBE) is useful to understand battery performance on a mechanistic level. We have seen that battery performance is governed by short range (<20 um) electron transfer between the active material and carbon binder domain (CBD) within electrodes. Available imaging techniques for visualizing the electronic connectivity of LIBEs, however, are limited to nanoscale, single particle resolutions using sophisticated synchrotron X-ray or electron microscopy. Optical microscopy offers the correct spatial resolution for visualizing the submicron connection of CBD to active particles but is limited by colorimetry of electrode materials—with graphite being the exception due to its visible color change during lithiation.

There is a rapidly growing body of research interested in studying the ionic diffusion pathways of Li-ion using operando optical microscopy, however none currently exist for studying the submicron electronic connectivity through an operando approach-especially under an industrially applicable lens. Here is disclosed the first spatially- and time-resolved technique for visualizing the electronic connectivity of commercial LIBEs using operando electrochemical fluorescent microscopy (EFM).

This technique relies on the principle of electrofluorochromism, which is used to advantage here for a simple electrochemical system involving heterogeneous electron transfer. This allows us to use fluorescence as a real-time tracker for electronic heterogeneity, where electronic ‘dead-zones’ present as non-fluorescent regions in 2D images.

Using our technique, we visualize commonly used commercial LIBEs (carbon content 1-4%, regimented processing), including NMC (LiNiₓMn_{y}Co_{1-x-y}O₂), LFP (LiFePO₄), and LCO (LiCoO₂) against formulaically similar in-house made LIBEs (<3.5% carbon content) as a proof of concept. One can expect that commercially made LIBEs will have little to no electronic ‘dead-zones’ when compared to those made in-house.

Global feature extraction on post-processed images is performed to quantify electrode topology and evaluate electronic connectivity of active particles of battery electrodes, as well as heterogeneous mapping to determine the heterogeneity index of electrodes imaged.

This quick (<1 hr), reproducible visualization technique is general enough to be used to study the electronic connectivity of emerging new battery electrodes, as well as verify commercially available ones. This approach presents the opportunity to save months to years of battery electrode testing by being used as an alternative to lengthy full cell testing for LIBEs.

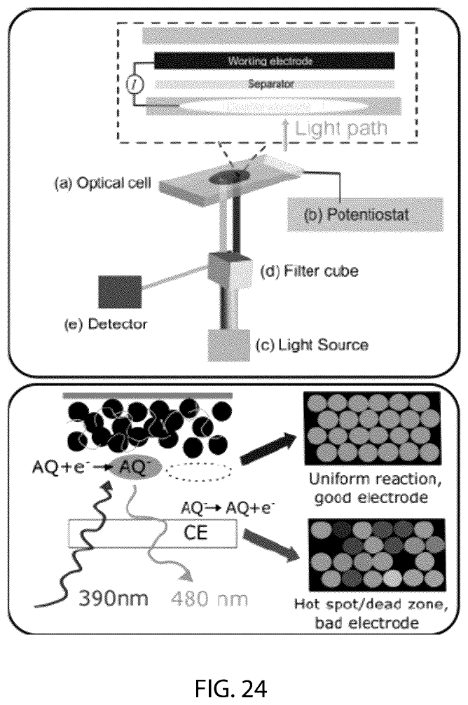

The principle is illustrated in exemplary FIG. 24. Monochromatic ultraviolet light illuminates the sample, while emitted visible light creates a two-dimensional image. In EFM, emission originates from a redox-active fluorophore, or electrofluorophore, added to the battery electrolyte. This molecule is inactive until it is electrochemically and reversibly reduced at the composite battery electrode. Only the particles of active material that are electronically connected to the current collector via the CBD can transfer electrons to the electrofluorophore. Thus, the local fluorescent signal intensity corresponds to reaction activity, which is in turn limited by local electronic accessibility. Oxidative regeneration of the electrofluorophore at the transparent counter electrode (CE) prevents reactant depletion during the experiment.

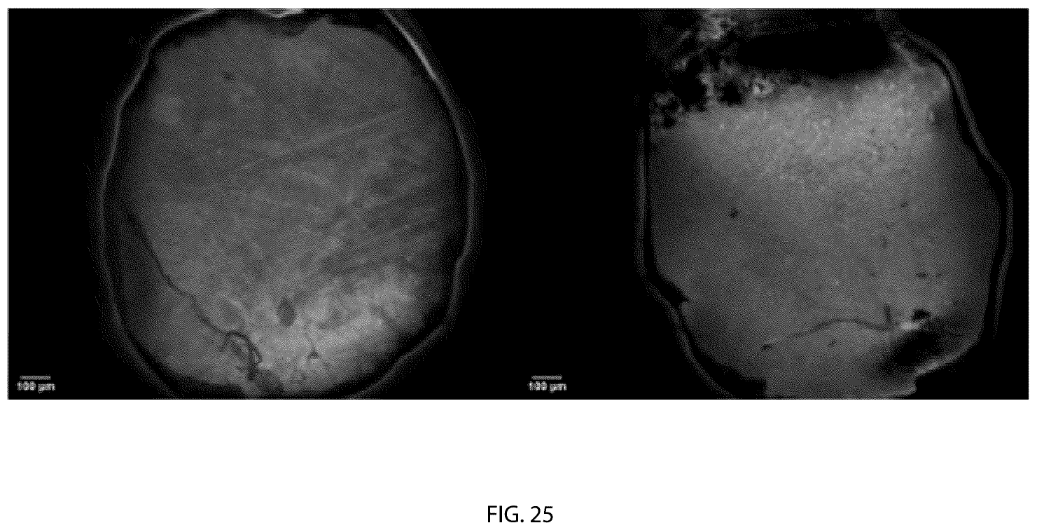

It is demonstrated that EFM can measure the electronic accessibility of battery electrode regions and particles, and that the heterogeneity of electronic accessibility qualitatively correlates to the electrode performance. As an example, FIG. 25 compares a high-performance commercial LiNi_{0.33}Mn_{0.33}Co_{0.33}O₂ (NMC) electrode to a poor-performance in-house electrode made with low CBD content (<5% mass). There are differences in hot-spots, dead zones, and overall heterogeneity between the two samples.

One can hypothesize that electrode heterogeneity, as measured by fluorescent signal, is correlated to electrode performance. Image textural analysis is a dynamic topic in computer science, biomedical engineering, and other fields, but is not widely used in electrochemical engineering. One can compute classical descriptors of image heterogeneity including deviation, skewness, kurtosis, and image entropy as well as newer measures of heterogeneity that incorporate spatial dependence. These metrics can be correlated to coin cell cycle life, rate performance, and variation between samples. Measuring electronic accessibility before and after cycling provides additional information.

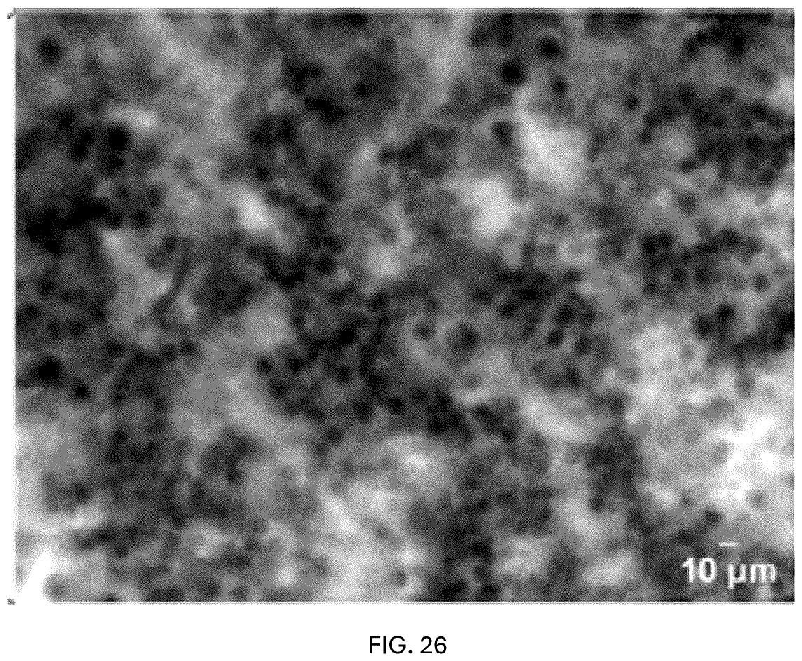

Preliminary images at higher magnification show dark spots of low electronic accessibility in low-performing NMC electrodes (FIG. 26). We attribute these dark spots to isolated particles of NMC based on the perfect match between shape and diameter as well as consistency with our theoretical mechanism (FIG. 24). No spots are observed when nanometer-scale active material particles are used, further supporting our interpretation. Image segmentation is the process of automatically identifying components of interest. Its numerous applications include counting cars in aerial traffic photos, recognizing insect pests in infrared crop images, and identifying tumors from stained tissue samples.

### Derivations for Limiting Current Calculations

The diffusivity of AQ in the electrolyte solution is found from the Randles-Secvik equation (Equation 1) to be

$${D}_{A Q} \cdot - = 6.03 \cdot {10}^{- 7} \frac{{cm}^{2}}{s} .$$

Results from FIG. 4 show good linearity of peak cathodic currents which indicates that, as expected, reaction rates are diffusion limited. We perform this characterization on a well-behaved glassy carbon disk in a three-electrode set up under Argon.

$${i}_{p , red} = 2.69 E 5 {n}^{\frac{2}{3}} {{AD}_{{AQ}^{\cdot -}}}^{\frac{1}{2}} {v}^{\frac{1}{2}} \qquad ( 1 )$$

Where n the number of electrons exchanged, A is the area of the planar electrode surface, D_{AQ}_{^{•−}} is the diffusivity of the reduced species, and v is applied scan-rate.

Because AQ is a dilute species in supporting electrolyte, Fick's Law describes the transport. Assuming that reversible reduction of AQ is the only reaction at the working electrode and oxidative regeneration of AQ from AQ− is the only reaction at the counter electrode yields the limiting current:

$$- {J}_{reduced} ( 0 , t ) = \frac{{i}_{app}}{nFA} = {{D}_{0} [ \frac{\partial {c}_{o}}{\partial x} ]}_{x = 0} \qquad ( 2 )$$

$${i}_{lim} = - \frac{{nFAD}_{{AQ}^{\cdot - {C}_{o}}}}{δ} \qquad ( 3 )$$

Where F is Faraday's constant, Cₒ is the initial concentration of the solution, and δ is the diffusion layer thickness.

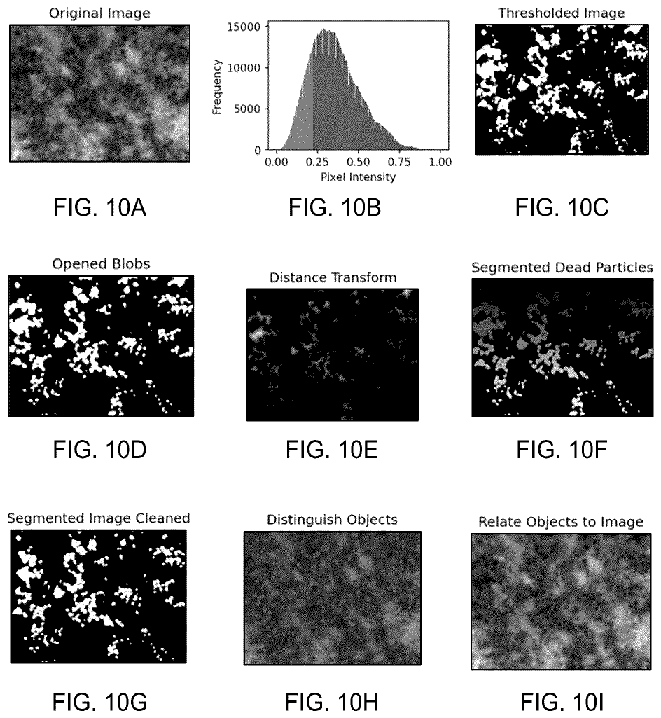

The principle of in-situ EFM assumes that the darkest image blobs correspond to the most electronically isolated particles. To detect these particles, EFM images were normalized from pixel intensities of [0, 255] to a range of [0,1]. The greyscale image was binarized dynamically using a percentile approach, where we threshold to only include pixels which fall below 65% of the median data. The binarized images show dark blobs represented in white, which are hypothesized electronically disconnected particles, in isolation and agglomeration (FIG. 10C). To remove small artifacts, morphological opening is performed on binarized images with a circular structuring element size of 5 pixels in size, about 1.5 um (FIG. 10D). Pre-processed images must undergo segmentation to delineate agglomerates, which appear as overlapping blobs in images. To seed images for segmentation, distance mapping is performed to determine the center regions in binarized images. The Euclidean distance is calculated between foreground pixels (blobs) and background (not blobs) to create a distance map (FIG. 10E). A maximum distance of 0.5 difference was selected to minimize information loss, based on trial and error. The Watershed algorithm utilizes the gradient from the mapping input to segment agglomerates, using the seeded foreground pixels with a minimum distance of 15 pixels or 5 ums, equivalent to the radius of suspected disconnected particles (FIG. 10F). Now segmented, the image is cleaned up by applying a morphological operation which discounts fragmented blobs touching the perimeter (FIG. 10G). Segmented components undergo feature extraction (FIG. 10H) and are displayed overlapping onto the original image for verification (FIG. 10I)

### Aspects

The following Aspects are illustrative only and do not limit the scope of the present disclosure or the appended claims. Any part or parts of any one or more Aspects can be combined with any part or parts of any one or more other Aspects.
Aspect 1. A method, comprising: visualizing, with electrochemical fluorescent microscopy, electronic connections between particles of active material and conductive additive in a composite battery electrode.
Aspect 2. The method of Aspect 1, wherein the composite battery electrode associates with a lithium-ion battery.
Aspect 3. The method of any one of Aspects 1-2, further comprising identifying locations of relatively low electronic accessibility in the composite battery electrode.
Aspect 4. The method of Aspect 3, wherein the identifying is performed in an automated fashion.
Aspect 5. The method of any one of Aspects 1-4, further comprising contacting the composite battery electrode with an electrofluorophore. Anthroquinone is an example, non-limiting electrofluorophore: other electrofluorophores can be used.
Aspect 6. The method of Aspect 5, further comprising electrochemically reducing the electrofluorophore
Aspect 7. The method of Aspect 6, further comprising oxidative regeneration of the electrofluorophore.
Aspect 8. A testing apparatus, comprising: a transparent conductor: a composite battery electrode, the transparent conductor and composite battery electrode being in electronic communication with one another: a separator disposed between the transparent conductor and the composite battery electrode: a medium, the medium comprising an electrofluorophore, and the medium contacting the composite battery electrode.
Aspect 9. The testing apparatus of Aspect 8, further comprising a light source and a detector, the light source being configured to illuminate the composite battery electrode and the electrofluorophore in the medium, and the detector being configured to collect emissions from the electrofluorophore.
Aspect 10. The testing apparatus of Aspect 9, further configured to (i) display a representation of the emissions from the electrofluorophore, (ii) identify locations of relatively low electronic accessibility in the composite battery electrode, or both (i) and (ii).
Aspect 11. A method, comprising: collecting a fluorescence image representative of a composite material that (i) comprises a plurality of particles and (ii) comprises an electrofluorophore; and estimating particles of the composite electrode that are in electronic isolation.

An image can be, for example, an EFM image. An image can provide a spatial and/or temporal record of the composite material. In this way, one can determine spatial, temporal, or both kinds of information concerning the material. In this way, a user can monitor the condition or performance of the material as a function of location within the material, as a function of the time during which the material has been used, and the like. This approach thus affords useful diagnostic information that can allow a user to determine the cause of a poor-performing material. A user can also assess a material for possible purchase: other uses of the technology will be apparent to the user of ordinary skill in the art.
Aspect 12. The method of Aspect 11, further comprising assigning an intensity value to pixels of the fluorescence image.
Aspect 13. The method of Aspect 12, further comprising consideration of pixels having an intensity above or below a threshold value.
Aspect 14. The method of any one of Aspects 11-13, further comprising segmenting the fluorescence image so as to delineate particle agglomerates.
Aspect 15. The method of Aspect 14, wherein the segmenting comprises application of a Watershed algorithm.
Aspect 16. The method of any one of Aspects 11-15, further comprising relating particles of the composite electrode that are in electronic isolation to a performance characteristic of the composite electrode.
Aspect 17. The method of Aspect 16, wherein the performance characteristic comprises an extent of electronic connectivity among particles of the composite electrode.
Aspect 18. The method of any one of Aspects 11-17, wherein the intensity of a pixel of a particle is indicative of an electronic connectivity of the particle. Aspect 19. The method of any one of Aspects 11-18, wherein the image is collected while passing current through the composite material.
Aspect 20. The method of Aspect 19, wherein the composite material is characterized as an electrode.

What is claimed:

1. A method, comprising:
visualizing, with electrochemical fluorescent microscopy, electronic connections between particles of active material and conductive additive in a composite battery electrode.

2. The method of claim 1, wherein the composite battery electrode associates with a lithium-ion battery.

3. The method of claim 1, further comprising identifying locations of relatively low electronic accessibility in the composite battery electrode.

4. The method of claim 3, wherein the identifying is performed in an automated fashion.

5. The method of claim 1, further comprising contacting the composite battery electrode with an electrofluorophore.

6. The method of claim 5, further comprising electrochemically reducing the electrofluorophore.

7. The method of claim 6, further comprising oxidative regeneration of the electrofluorophore.

8. A testing apparatus, comprising:
a transparent conductor;
a composite battery electrode,
the transparent conductor and composite battery electrode being in electronic communication with one another;
a separator disposed between the transparent conductor and the composite battery electrode;
a medium,
the medium comprising an electrofluorophore, and
the medium contacting the composite battery electrode.

9. The testing apparatus of claim 8, further comprising a light source and a detector,
the light source being configured to illuminate the composite battery electrode and the electrofluorophore in the medium, and
the detector being configured to collect emissions from the electrofluorophore.

10. The testing apparatus of claim 9, further configured to (i) display a representation of the emissions from the electrofluorophore, (ii) identify locations of relatively low electronic accessibility in the composite battery electrode, or both (i) and (ii).

11. A method, comprising:
collecting a fluorescence image representative of a composite material that (i) comprises a plurality of particles and (ii) comprises an electrofluorophore; and
estimating particles of the composite material that are in electronic isolation.

12. The method of claim 11, further comprising assigning an intensity value to pixels of the fluorescence image.

13. The method of claim 12, further comprising consideration of pixels having an intensity above or below a threshold value.

14. The method of claim 11, further comprising segmenting the fluorescence image so as to delineate particle agglomerates.

15. The method of claim 14, wherein the segmenting comprises application of a Watershed algorithm.

16. The method of claim 11, further comprising relating particles of the composite material that are in electronic isolation to a performance characteristic of the composite electrode.

17. The method of claim 16, wherein the performance characteristic comprises an extent of electronic connectivity among particles of the composite material.

18. The method of claim 11, wherein an intensity of a pixel of a particle is indicative of an electronic connectivity of the particle.

19. The method of claim 11, wherein the image is collected while passing current through the composite material.

20. The method of claim 19, wherein the composite material is characterized as an electrode.
